(19) United States
(12) Patent Application Publication
(10) Pub. No.: US 2022/0084206 A1
(43) Pub. Date: Mar. 17, 2022

(54) INFORMATION PROCESSING APPARATUS, INFORMATION PROCESSING METHOD, AND NON-TRANSITORY STORAGE MEDIUM

(71) Applicant: CANON KABUSHIKI KAISHA, Tokyo (JP)

(72) Inventors: Ryo Ishikawa, Kanagawa (JP); Toru Tanaka, Chiba (JP); Kiyohide Satoh, Kanagawa (JP); Hiroshi Moriya, Fukushima (JP)

(21) Appl. No.: 17/468,475

(22) Filed: Sep. 7, 2021

(30) Foreign Application Priority Data
Sep. 11, 2020 (JP) 2020-153003

(51) Int. Cl. G06T 7/00; G06T 7/246

(52) U.S. Cl. CPC G06T 7/0016; G06T 7/246; G06T 2207/10104; G06T 2207/10081; G06T 2207/10088; G06T 2207/30061

(57) ABSTRACT

An information processing apparatus includes a first acquisition unit configured to acquire a characteristic amount relating to movement of a target site of a subject, a second acquisition unit configured to acquire a standard characteristic amount, based on a characteristic amount relating to movement of a target site of a standard subject different from the subject, and a calculation unit configured to calculate a characteristic value relating to the movement of the target site of the subject, based on the characteristic amount relating to the movement of the target site of the subject and the standard characteristic amount, wherein the second acquisition unit performs a coordinate transformation of the characteristic amount of the standard subject into a reference space, and calculates the standard characteristic amount, based on a characteristic amount resulting from the coordinate transformation.

### BACKGROUND

### Field of the Disclosure

The present disclosure relates to an information processing apparatus, an information processing method, and a non-transitory storage medium.

### Description of the Related Art

At a medical site, an image of a patient is captured by a medical image capturing apparatus such as an X-ray computed tomography (CT) apparatus, a magnetic resonance imaging (MRI) apparatus, or a position emission tomography (PET) apparatus. An anatomical structure of various types of organs in the body of the patient and functional information thereof are obtained by observing the captured medical image in detail, and the obtained information is used in diagnosis and treatment.

Among various types of organs in a human body, there is a type of organ that moves with respect to surrounding organs. For example, lungs move caused by respiratory movement, and a heart moves to circulate blood in the body. It is known that, even in the same organ, a movement (a movement direction or a movement amount) relative to the periphery varies depending on a position in the organ or on the surface thereof (hereinafter, referred to as a position-within-organ), because of the structure of the organ or the presence/absence of a lesion. There is a demand from users (such as a doctor) to recognize a position-within-organ having an abnormal movement to find a lesion, by visualizing a difference in movement direction or movement amount (hereinafter, referred to as movement information) depending on the position-within-organ of a target organ (i.e., by visualizing the distribution of movement directions or movement amounts), from medical images. For example, there is a demand to identify an adhesion position on a surface of a lung from medical images by visualizing a difference in movement information caused by respiratory movement of the lung, with respect to a difference in position on the surface of the lung.

Japanese Patent Application Laid-Open No. 2016-67832 discusses a technique of calculating an amount of a slip of a surface position caused by respiratory movement and deeply connected with an adhesion on the surface of a lung.

### SUMMARY

The present disclosure is directed to an information processing apparatus that can more accurately grasp an abnormality degree of movement of a target site, by reflecting characteristics of movement of a target site that vary from position to position in a normal target site.

According to an aspect of the present disclosure, an information processing apparatus includes a first acquisition unit configured to acquire a characteristic amount relating to movement of a target site of a subject, a second acquisition unit configured to acquire a standard characteristic amount, based on a characteristic amount relating to movement of a target site of a standard subject different from the subject, and a calculation unit configured to calculate a characteristic value relating to the movement of the target site of the subject, based on the characteristic amount relating to the movement of the target site of the subject and the standard characteristic amount, wherein the second acquisition unit performs a coordinate transformation of the characteristic amount of the standard subject into a reference space, and calculates the standard characteristic amount, based on a characteristic amount resulting from the coordinate transformation.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an information processing system according to a first exemplary embodiment.

FIG. 2 is a flowchart illustrating an overall processing procedure according to the first exemplary embodiment.

FIG. 3 is a diagram illustrating respiratory movement of a lung.

FIG. 4 is a flowchart illustrating a processing procedure for acquiring standard slip amount map according to the first exemplary embodiment.

FIG. 5 is a diagram illustrating a coordinate transformation into a reference space.

FIG. 6 is a flowchart illustrating a processing procedure for calculating characteristic value map according to the first exemplary embodiment.

FIG. 7 is a flowchart illustrating an overall processing procedure according to a second exemplary embodiment.

FIG. 8 is a flowchart illustrating a processing procedure for acquiring standard slip amount map according to the second exemplary embodiment.

### DESCRIPTION OF THE EMBODIMENTS

An information processing system according to a first exemplary embodiment of the present disclosure provides a user such as a doctor or a technician in a medical institution with a function of supporting a grasp and a diagnosis of an adhesion state of a pleura of a subject, which is an inspection target. To be more specific, the information processing system provides a function of generating an observation image from which it is easy for the user to visually recognize the difference from a normal case (standard subject) having no adhesion in a pleura, in terms of a slip state of a pleura that is one type of characteristic amount relating to a motion (movement) of a lung (target site) of a subject, which is an inspection target.

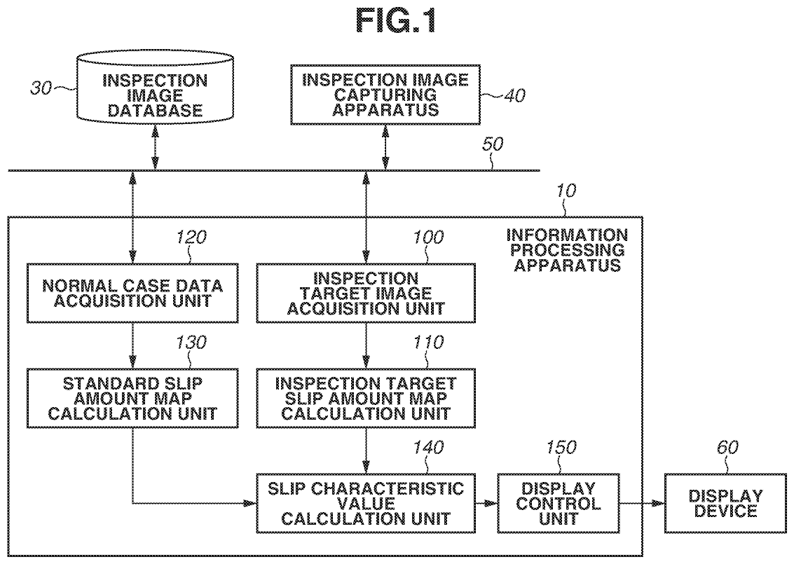

FIG. 1 is a block diagram illustrating an overall configuration of an information processing system according to the present exemplary embodiment. The information processing system includes an information processing apparatus 10, an inspection image database 30, and an inspection image capturing apparatus 40, and these apparatuses are communicably connected to each other via a communication network. In the present exemplary embodiment, the communication network is a local area network (LAN) 50, but may be a wide area network (WAN). The connection method of the communication network may be wired connection, or may be wireless connection.

The inspection image database 30 holds a plurality of inspection images relating to a plurality of patients, and additional information thereof. The inspection image is, for example, a medical image captured by an image diagnosis apparatus such as a computed tomography (CT) apparatus or a magnetic resonance imaging (MRI) apparatus, and can be any of a two-dimensional (2D) image, a three-dimensional (3D) image, and a four-dimensional (4D) image that is a 3D moving image. Further, each of the images can be any of images in various modes such as monochrome and color. The inspection image database 30 in the present exemplary embodiment holds 4D-CT data of an inspection target subject. The inspection image database 30 holds a patient name (patient identification (ID)), inspection date information (date when an inspection image is captured), a modality name corresponding to the inspection image, etc., as the additional information for the inspection image. Each of the inspection images and the additional information thereof are assigned a unique number (inspection image ID) so as to be distinguished from others, so that the information processing apparatus 10 can read out the information, based on the unique number. The inspection image database 30 further holds inspection images of a plurality of normal cases other than the inspection target subject, and slip amount maps thereof to be described in detail below. The normal cases each have no adhesion in a pleura. Further, the inspection image database 30 may hold inspection images and slip amount maps, for cases each having an adhesion in a pleura and cases each being unclear in terms of the presence/absence of an adhesion. In this case, it is desirable to hold information that enables these cases to be distinguished from the above-described normal cases, as additional information.

The information processing apparatus 10 acquires the information held in the inspection image database 30, via the LAN 50.

An inspection target image acquisition unit 100 acquires the inspection image of the inspection target subject captured by the inspection image capturing apparatus 40 and held in the inspection image database 30.

An inspection target slip amount map calculation unit 110 (first acquisition unit) analyzes the inspection image acquired by the inspection target image acquisition unit 100, and calculates a slip amount (characteristic amount) map of a pleura of a subject as will be described in detail below.

A normal case data acquisition unit 120 acquires information about slip amounts of a plurality of normal cases (described in detail below) different from the inspection target subject, from the inspection image database 30.

A standard slip amount map calculation unit 130 (second acquisition unit) calculates a standard slip amount (standard characteristic amount) map of the normal cases, from the information about the slip amounts of the normal cases acquired by the normal case data acquisition unit 120.

A slip characteristic value calculation unit 140 (calculation unit) calculates a characteristic value relating to the slip amount of the inspection target subject (characteristic value relating to the movement of the target site), by executing a comparison operation for comparison between the slip amount (characteristic amount) map of the inspection target subject calculated by the inspection target slip amount map calculation unit 110 and the standard slip amount (standard characteristic amount) map calculated by the standard slip amount map calculation unit 130.

A display control unit 150 controls a display device 60 (display unit) to display the characteristic value calculated by the slip characteristic value calculation unit 140.

The configuration of the information processing system illustrated in FIG. 1 is merely an example. For example, the information processing apparatus 10 may include a storage unit (not illustrated) and have the function of the inspection image database 30.

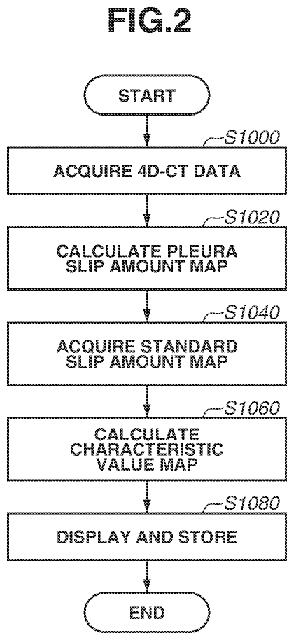

Next, an overall processing procedure by the information processing apparatus 10 in the present exemplary embodiment will be described in detail with reference to FIG. 2. A case where CT data is used as the inspection image will be described below as an example, but the implementation of the present disclosure is not limited thereto. For example, an MRI image or an ultrasound image may be used if the image is time-series 3D volume data obtained by capturing an image of a lung.

### <Acquisition of 4D-CT Data>

In step S1000, the inspection target image acquisition unit 100 (image acquisition unit) acquires 4D-CT data obtained by capturing an image of a lung field of an inspection target subject, from the inspection image database 30. The 4D-CT data in the present exemplary embodiment is time-series 3D volume data, and is data obtained by capturing an image of moving state caused by breathing of the inspection target subject. To be more specific, the inspection target image acquisition unit 100 acquires 4D-CT data composed constituted by 3D-CT data at each of two points in time, i.e., an inspiratory level (e.g., a maximal inspiratory level) and an expiratory level (e.g., a maximal expiratory level) of the inspection target subject. In other words, the inspection target image acquisition unit 100 (image acquisition unit) acquires a plurality of pieces of data (including images) obtained by capturing an image of the lung field of the inspection target subject at different time phases. In the present exemplary embodiment, the 3D-CT data at the inspiratory level will be referred to as the 3D-CT data I_t_ins, and the 3D-CT data at the expiratory level will be referred to as the 3D-CT data I_t_exp. The 4D-CT data including these pieces of data will be referred to as the 4D-CT data I_t. In these pieces of 3D-CT data in the present exemplary embodiment, the image of the entire lung of the inspection target subject is captured.

In the present exemplary embodiment, the case where the 3D-CT data at each of the two different points in time that are the inspiratory level and the expiratory level is used, is described as an example, but the implementation of the present disclosure is not limited thereto. 3D-CT data at each of two points in time corresponding to other respiratory states may be used if an image of a motion of the lung field caused by breathing of the inspection target subject is captured. However, from the viewpoint of the consistency between a slip amount map of the inspection target subject to be calculated in step S1020 to be described below and a slip amount map of a normal case to be acquired in step S1040 (i.e., processing in step S10400) to be described below, it is desirable to use the same respiratory states as respiratory states at two points in time used to calculate the slip amount map of the normal case.

### <Calculation of Pleura Slip Amount Map>

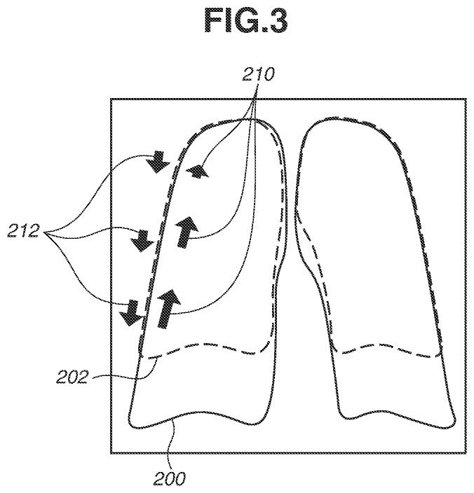

In step S1020, the inspection target slip amount map calculation unit 110 (first acquisition unit) calculates a slip amount (characteristic amount relating to the movement of the target site) map representing a slip amount resulting from breathing, in a contour portion of the lung (target site) of the inspection target subject. In the present exemplary embodiment, a case where a slip amount map relating to the right lung of the inspection target subject is calculated will be described as an example. The slip amount (characteristic amount) in the contour portion of the lung based on breathing will be described with reference to FIG. 3. FIG. 3 is a diagram illustrating a coronal plane of the lung at the inspiratory level and the expiratory level of the lung. In FIG. 3, a shape 200 represents a contour shape of the lung at the inspiratory level. Further, a shape 202 represents a contour shape of the lung at the expiratory level. In this way, the contour shape of the lung at the inspiratory level and that at the expiratory level are different. An arrow 210 in FIG. 3 represents breathing-based movement of the lung from the inspiratory level to the expiratory level, at each position of a lung contour. Further, an arrow 212 represents breathing-based movement of a chest wall from the inspiratory level to the expiratory level, at each position of the lung contour. As indicated by the direction and the size of each of the arrows 210 and the arrows 212 in FIG. 3, a motion accompanied by a slip at the position of a pleura between the lung field side and the chest wall side is caused by breathing, at each position of the lung contour. In this processing step, a slip amount at each position of the lung contour is calculated. In this case, any known technique may be used to calculate the slip amount. For example, the slip amount can be calculated by performing deformation registration between the image at the inspiratory level and the image at the expiratory level, and calculating a moving amount of each point on the image. To be more specific, the calculation can be executed using a method discussed in Japanese Patent Application Laid-Open No. 2016-67832.

The slip amount (characteristic amount) at each position of the contour of the lung at the inspiratory level of the inspection target subject is calculated by the above-described processing. In general, in a case where a pleural adhesion is present in a subject, a slip amount tends to be small at this adhesion point. In the present exemplary embodiment, a case where the slip amount is calculated at predetermined intervals (e.g., 1 mm) in the entire contour of the lung of the inspection target subject will be described as an example. In the present exemplary embodiment, a position on the contour at which the slip amount is calculated is expressed as a position P_t_i (1≤i≤N), and a slip amount calculated at this position is expressed as a slip amount S_t_i (1≤i≤N). In this case, i is an index for identifying each of a plurality of positions on the contour, and N is a total number of the positions on the contour. In the present exemplary embodiment, the N number of slip amounts S_t_i are held as a slip amount map S_t. The slip amount map S_t is a function that returns, using the position of the inspiratory level in a 3D-CT data image coordinate system an as argument, the slip amount at this position. To be more specific, the slip amount map S_t is held as volume data discretized at the same level as 3D-CT data.

### <Acquisition of Standard Slip Amount Map>

In step S1040, the information processing apparatus 10 acquires from the inspection image database 30 information representing slip amounts of a plurality of subjects (standard subject) each having no pleural adhesion, and acquires a standard slip amount (standard characteristic amount) map by calculating the average value of those slip amounts. The standard slip amount map in the present exemplary embodiment is acquired by performing averaging processing on the slip amount maps of subjects different from the inspection target subject and each having no adhesion in a pleura. This standard slip amount map represents the average slip amount of the subjects each having no adhesion.

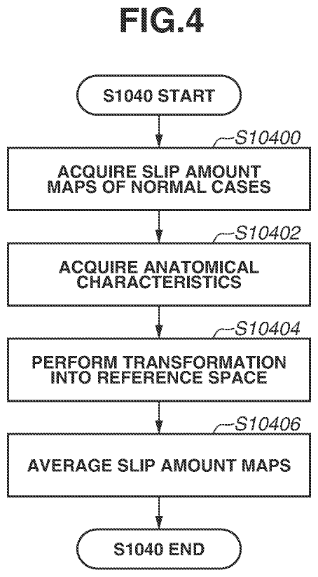

FIG. 4 is a flowchart illustrating the processing flow of this step in more detail. The detailed flow of the processing in step S1040 will be described below with reference to FIG. 4.

### <Acquisition of Slip Amount Maps of Normal Cases>

In step S10400, the normal case data acquisition unit 120 acquires slip amount maps of a plurality of normal cases (cases each having no pleural adhesion) from the inspection image database 30. The inspection image database 30 of the present exemplary embodiment holds inspection images relating to a plurality of subjects and additional information thereof. This additional information includes slip amount maps of these subjects and diagnosis information about the presence/absence of an adhesion in a pleura. In this processing step, the normal case data acquisition unit 120 searches the inspection image database 30 based on a condition of “normal case (no pleural adhesion)”, and acquires an inspection image including 4D-CT data of a case extracted as a result of the search and a slip amount map serving as the additional information. In the present exemplary embodiment, an M number of cases are extracted as the normal cases, 4D-CT data of each of the M number of cases is expressed as 4D-CT data I_n_j (1≤j≤M), and a slip amount map of each of the M number of cases is expressed as a slip amount map S_n_j (1≤j≤M). In the present exemplary embodiment, there will be described a case where the right lung of the inspection target subject is used as a target, and the above-described slip amount map S_n_j (1≤j≤M) of the normal case is also a slip amount map of the right lung of the normal case. The 4D-CT data I_n_j (1≤j≤M) of each of the cases includes 3D-CT data I_n_ins_j (1≤j≤M) at the inspiratory level and 3D-CT data I_n_exp_j (1≤j≤M) at the expiratory level of each of the cases. In this case, the form of each of the 4D-CT data the 3D-CT data I_n_ins_j, the 3D-CT data I_n_exp_j, and the slip amount map S_n_j is similar to the form of the corresponding piece of data of the inspection target subject described in step S1000.

The case where the slip amount map S_n_j of each of the plurality of normal cases held in the inspection image database 30 is read out and acquired is described above as an example, but the implementation of the present disclosure is not limited thereto. For example, the slip amount map S_n_j may be calculated by applying processing similar to that in step S1020 to the 4D-CT data I_n_j of each of the plurality of normal cases.

### <Acquisition of Anatomical Characteristics>

In step S10402, the standard slip amount map calculation unit 130 acquires anatomical characteristics in each of the normal cases, based on the 3D-CT data I_n_ins_j (1≤j≤M) at the inspiratory level included in the 4D-CT data I_n_j (1≤j≤M) acquired in step S10400. In the present exemplary embodiment, a case where a lung contour, a lung apex position, and a lung base position are acquired, will be described as a specific example. These acquisitions can be performed using a known organ segmentation technique or shape analysis technique. Alternatively, a mechanism that can acquire these positions by a user manual operation may be included and these positions may be acquired based on this mechanism. In the present exemplary embodiment, the lung apex position and the lung base position are acquired as 3D position information on the 3D-CT data I_n_ins_j (1≤j≤M) at the inspiratory level. Specifically, the position of a point farthest away from the lung apex position on a lung base plane where a lung field and a diaphragm are in contact with each other can be acquired as the lung base position. Alternatively, a point at the average distance from the lung apex or a point on the back side of the subject may be selected from a plurality of points on the contour of the lung base plane and the position of the selected point may be acquired. The lung contour, the lung apex position, and the lung base position acquired by the above-described processing are expressed as a lung contour L_n_j (1≤j≤M), a lung apex position Pt_n_j (1≤j≤M), and a lung base position Pb_n_j (1≤j≤M), respectively.

The case where the lung contour, the lung apex position, and the lung base position are acquired as the anatomical characteristics is described above, but the implementation of the present disclosure is not limited thereto, and other anatomical characteristics may be used if these characteristics can be used for transformation into a reference space to be executed in step S10404 to be described below. For example, a bronchus position or a lung side position may be acquired.

<Transformation into Reference Space>

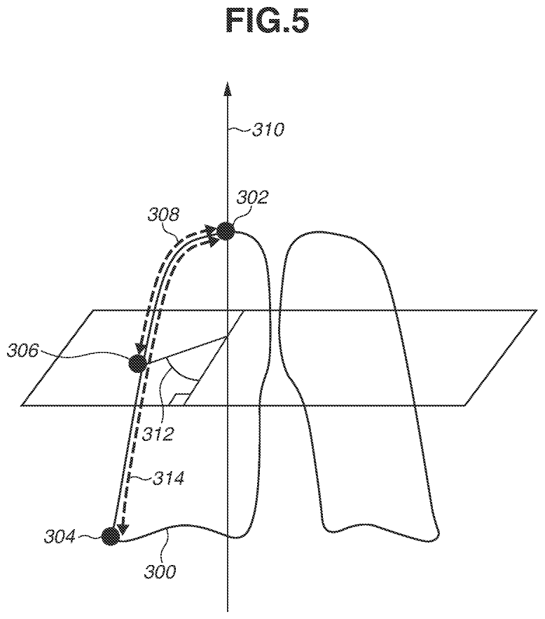

In step S10404, based on the lung contour, the lung apex position, and the lung base position of each of the normal cases acquired in step S10402, the standard slip amount map calculation unit 130 (second acquisition unit) performs a coordinate transformation of the slip amount (characteristic amount of the standard subject) map calculated in the 3D-CT image space at the inspiratory level of each of the cases into a reference space (first reference space). In this case, the reference space is a coordinate system in which a parameter relating to the position or shape of the lung serving as the target site is set at a coordinate axis, and the coordinate transformation into the reference space is a coordinate transformation for making the plurality of normal cases substantially match with each other in terms of anatomy, and is different for each of the cases. In the present exemplary embodiment, as a specific example of the coordinate transformation into the reference space, a case where a coordinate transformation into a coordinate system of a reference space expressed by two parameters that are 3a geodesic distance from the lung apex position and a direction around a body axis passing through the lung apex position is performed will be described in detail with reference to FIG. 5.

FIG. 5 is a diagram illustrating the lung contour simulated in a 3D space. In FIG. 5, the lung contour 300, the lung apex position 302, and the lung base position 304 acquired in step S10402 are illustrated. The slip amount map acquired in step S10400 has been calculated at each position on the lung contour 300. The lung contour in the actual processing is a curved surface in a 3D space, but in FIG. 5, the lung contour is displayed as a curve, for the sake of explanation. For an arbitrary position 306 on the lung contour 300, the standard slip amount map calculation unit 130 calculates a geodesic distance 308 from the lung apex position 302. The calculated geodesic distance 308 is d. The geodesic distance between two points on the curved surface can be calculated using a known technique and the detailed description thereof is omitted. Further, for the arbitrary position 306, the standard slip amount map calculation unit 130 calculates a direction 312 around a body axis 310 passing through the lung apex position 302. The calculated direction is Φ. The basis of the direction may be freely set, and, for example, the front side (direction toward the abdomen) of the subject can be set as Φ=0. The geodesic distance d of the arbitrary position 306 from the lung apex position 302 on the lung contour 300 and the direction Φ around the body axis 310 passing through the lung apex position 302 are calculated by the method described above. The coordinate transformation is performed by executing this calculation processing at every position on the lung contour. In other words, the coordinate transformation of the slip amount map calculated in the 3D-CT image space into the coordinate system of the reference space expressed by the two parameters d and Φ is performed. Subsequently, this coordinate transformation of the slip amount map is executed for each of all the normal cases, and a slip amount map S′_n_j (1≤j≤M) resulting from the coordinate transformation into the reference space is acquired. In the present exemplary embodiment, the slip amount map S′_n_j (1≤j≤M) is held as a 2D table discretized with predetermined granularity. Further, in the present exemplary embodiment, the slip amount map resulting from the above-described coordinate transformation is also expressed as a function S′_n_j (Φ, d) using Φ and d as arguments. Calling this function means looking up the above-described table, and interpolation processing in this process is appropriately performed.

The case where the geodesic distance from the lung apex position 302 to the arbitrary position 306 on the lung contour is d is described above as an example, but the implementation of the present disclosure is not limited thereto. For example, a value obtained by normalizing a geodesic distance from the lung apex position 302 using a geodesic distance 314 between the lung apex position 302 and the lung base position 304 may be d. With this method, there is such an effect that a coordinate transformation into a reference space adapted to the difference in lung size between the plurality of normal cases can be performed.

In addition, d is not necessarily a geodesic distance. For example, d may be a value that can be calculated in a simpler manner, such as a Euclidean distance or a one-dimensional distance in a body axis direction.

In addition, Φ is not necessarily a direction around a body axis. For example, Φ may be a direction around an axis passing through the lung apex position and the apex position of the diaphragm or the center of gravity of the lung field. With this method, there is such an effect that the coordinate transformation into the reference space can be performed in a robust manner, even in a case where the posture of the inspection target subject at the time of CT imaging is different from that in the normal case, and a case where the postures vary among the normal cases.

Further, the case where the coordinate transformation into the reference space is performed to place the lung apex position and the lung base position at the predetermined positions in the reference space is described above as an example, but the implementation of the present disclosure is not limited thereto. For example, an interlobar portion of the lung may be extracted from the image of each of the cases in step S10402, and the coordinate transformation into the reference space may be performed to place the interlobar portion of the lung at a predetermined position. In this case, since the left and the right in a normal lung structure of a human body are different in the number of lobes, it is desirable to change the processing depending on whether the processing target is the left lung or the right lung. With this method, a coordinate transformation for more accurately matching the anatomical characteristics of the normal cases is performed, and therefore, there is such an effect that a characteristic value map with higher accuracy can be generated as a result of processing in a subsequent stage to be described below.

### <Averaging Slip Amount Maps>

In step S10406, the standard slip amount map calculation unit 130 executes processing of calculating a standard slip amount (standard characteristic amount) map by integrating the slip amount maps S′_n_j (1≤j≤M) of the respective normal cases resulting from the coordinate transformation into the reference space in step S10404. In the present exemplary embodiment, the standard slip amount map is expressed as a standard slip amount map R′_n. In the present exemplary embodiment, a case where an average value calculation operation is used as an operation for integrating the slip amount maps of the plurality of normal cases will be described as an example. Specifically, the standard slip amount map R′_n is calculated by an equation (1).

$${R}^{′} \_n ( Φ , d ) = \frac{{\sum }_{j = 1}^{M} {S}^{′} \_n \_j ( Φ , d )}{M} \qquad ( 1 )$$

In the present exemplary embodiment, the standard slip amount map R′_n is held as a 2D table discretized with granularity at the same level as that of the slip amount map S′_n_j (1≤j≤M).

The processing in step S1040 is achieved by the above-described processing in step S10400 to step S10406.

In the present exemplary embodiment, the case where the transformation into the reference space is performed based on the anatomical characteristics at the inspiratory level of the normal case is described as an example, but the implementation of the present disclosure is not limited thereto. For example, the coordinate transformation into the reference space may be performed based on anatomical characteristics at the expiratory level. In this case, a coordinate transformation into a reference space to be executed as processing in step S1060 to be described below is similarly executed based on the anatomical characteristics at the expiratory level. Further, in addition to the acquisition of the standard slip amount map by the coordinate transformation based on the anatomical characteristics at the inspiratory level, the acquisition of a standard slip amount map by the coordinate transformation based on the anatomical characteristics at the expiratory level may also be executed. In this case, a characteristic value map to be calculated in step S1060 to be described below can be calculated for both of the inspiratory level and the expiratory level, or the calculation of the characteristic value map can be switched between these respiratory states based on an instruction input by the user.

The processing in step S1040 is not limited to the above-described method. For example, there may be adopted such a configuration that the above-described processing in step S10400 to step S10406 is executed beforehand, and the result of the processing is held in the inspection image database 30 and read in step S1040.

### <Characteristic Value Map Calculation>

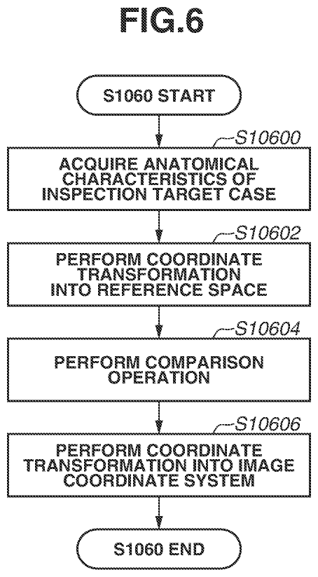

In step S1060, the slip characteristic value calculation unit 140 calculates a characteristic value map relating to the slip amount of the inspection target subject (characteristic value relating to the movement of the target site), by comparing the slip amount map S_t of the inspection target subject calculated in step S1020 and the standard slip amount map R′_n calculated in step S1040. FIG. 6 is a flowchart illustrating the processing flow of this step more in detail. The detailed flow of the processing in step S1060 will be described below with reference to FIG. 6.

### <Acquisition of Anatomical Characteristics of Inspection Target Case>

In step S10600, the slip characteristic value calculation unit 140 (calculation unit) executes processing of acquiring a lung contour, a lung apex position, and a lung base position at the inspiratory level from the 4D-CT data of the inspection target case acquired in step S1000. This processing is similar to that in step S10402 executed for the normal cases, and the detailed description thereof is omitted here. The lung contour, the lung apex position, and the lung base position acquired by this processing are expressed as a lung contour L_t, a lung apex position Pt_t, and a lung base position Pb_t, respectively.

<Coordinate Transformation into Reference Space>

In step S10602, the slip characteristic value calculation unit 140 executes processing of performing a coordinate transformation of the slip amount (characteristic amount) map S_t of the inspection target subject acquired in step S1020 into a reference space (second reference space), based on the lung contour, the lung apex position, and the lung base position acquired in step S10600. Here, the reference space is the space of the standard slip amount map R′_n acquired in step S1040, and this is a space expressed by two parameters that are a geodesic distance d from the lung apex position and a direction Φ around a body axis passing through the lung apex position. The coordinate transformation in this processing step is executed in a manner similar to the processing executed for the normal cases in step S10404. Thus, the detailed description thereof is omitted here.

A slip amount map of the inspection target subject resulting from the coordinate transformation by this processing is expressed as a slip amount map S′_t. The slip amount map S′_t is held as a 2D table discretized with predetermined granularity as with the standard slip amount map R′_n. Further, in the present exemplary embodiment, the slip amount map resulting from the above-described coordinate transformation is also expressed as a function S′_t (Φ, d) using Φ and d as arguments. Calling this function means looking up the above-described table, and interpolation processing in this process is assumed to be appropriately performed.

### <Comparison Operation>

In step S10604, the slip characteristic value calculation unit 140 (calculation unit) executes processing of performing a comparison operation for comparison between the slip amount map S′_t of the inspection target subject after the coordinate transformation calculated in step S10602 and the standard slip amount map R′_n calculated in step S1040, thereby calculating a characteristic value map C′_t relating to a slip of the pleura of the inspection target case. In the present exemplary embodiment, processing of calculating the logarithm of the ratio between the slip amount map S′_t and the standard slip amount map R′_n is executed as the comparison operation. Specifically, the characteristic value map C′_t is calculated by an equation (2).

$${C}^{′} \_t ( Φ , d ) = log ( \frac{{S}^{′} \_t ( Φ , d )}{{R}^{′} \_n ( Φ , d )} ) \qquad ( 2 )$$

The calculated characteristic value map C′_t is held as a 2D table discretized with predetermined granularity as with the slip amount map S′_t.

<Coordinate Transformation into Image Coordinate System>

In step S10606, the slip characteristic value calculation unit 140 executes processing of performing a coordinate transformation of the calculated characteristic value map C′_t in the reference space into the space of the 3D-CT data at the inspiratory level of the inspection target subject. This processing is executed as the inverse coordinate transformation of the coordinate transformation executed in step S10602. The inverse transformation of a given coordinate transformation may be executed by any known method. The detailed description thereof is omitted here. A characteristic value map C_t resulting from the coordinate transformation into the image space of the 3D-CT data at the inspiratory level of the inspection target subject is acquired by this processing.

The processing in step S1060 is executed by the flow described above, and the characteristic value map C_t is acquired. As apparent from the above-described calculation process, the characteristic value map C_t represents the magnitude ratio of the slip amount of the inspection target subject to the standard slip amount. A case where this value is small means that the slip amount of the inspection target subject is smaller than the standard slip amount. For example, this value tends to be smaller in a case where an adhesion is present in the pleura of the inspection target subject.

There is described above the case where the coordinate transformation of the slip amount of the inspection target subject into the reference space is performed, the comparison operation for comparison with the standard slip amount map in the reference space is performed, and the coordinate transformation of the result of the comparison operation into the image coordinate system is performed, but the implementation of the present disclosure is not limited thereto. For example, a coordinate transformation of the standard slip amount map into the image coordinate system of the inspection target subject may be performed, and the comparison operation may be performed in the image coordinate system. Alternatively, the standard slip amount map itself may be created in the image coordinate system of the inspection target subject, instead of being created in the reference space. This will be described in detail below as another exemplary embodiment.

### <Display and Storage>

In step S1080, the display control unit 150 (display control unit) controls the display device 60 (display unit) to display the characteristic value map of the inspection target subject calculated in step S1060. Specifically, the display control unit 150 generates an image (observation image) for observation of the characteristic value map C_t and displays the generated image on the display device 60. The observation image can be generated, for example, as a surface rendering image generated by subjecting the characteristic value map C_t to tone conversion using a gray scale or a color map, on a three-dimensional lung field contour shape of the inspection target subject. The observation image may also be generated by generating a volume rendering image of the 4D-CT data I_t and superimposing the above-described surface rendering image on the generated volume rendering image. Alternatively, the observation image may be generated by generating an arbitrary cross-sectional image from the 4D-CT data I_t based on a user operation, and superimposing pixel values obtained by subjecting the characteristic value map C_t to tone conversion using a color map or the like, on the position of the lung contour of the cross-sectional image. Further, not only the characteristic value map C_t, but also the slip amount map S_t acquired in step S1020 may be displayed. In this case, the observation image in which the characteristic value map C_t and the slip amount map S_t are arranged side by side may be generated, or a mechanism that can display either of these images by switching therebetween based on a user operation may be provided. The above-described method is merely an example of the present disclosure, and displaying the characteristic value map by any method or even not displaying the characteristic value map can be included in the exemplary embodiments of the present disclosure.

In this processing step, further, the information processing apparatus 10 may store the slip amount map S_t and the characteristic value map C_t in the inspection image database 30, in association with the 4D-CT data I_t acquired in step S1000.

The processing of the information processing apparatus 10 in the present exemplary embodiment is executed by the method described above. This makes it possible to grasp movement of an abnormal target site more accurately, by reflecting the characteristics of movement of a target site that vary from position to position in a normal target site. Moreover, there is such an effect that the user can be provided with the observation image that enables the user to easily confirm the difference from the normal case in terms of the slip amount of the pleura of the inspection target subject, by displaying the observation image on the display device 60 as in step S1080.

### Variation Example 1-1: Variation of Calculation Operation for Characteristic Value

The case where the characteristic value map C′_t is calculated using the logarithm of the ratio between the value of the slip amount map S′_t of the inspection target subject and the value of the standard slip amount map R′_n is described as a specific example of the processing in step S10604 in the present exemplary embodiment, but the implementation of the present disclosure is not limited thereto. For example, the characteristic value map C′_t may be calculated more simply by an operation for calculating the difference between the slip amount map S′_t and the standard slip amount map R′_n. Further, the case where the standard slip amount map is calculated as the average value of the slip amounts of the plurality of normal cases is described as an example of the processing in step S1040, but the implementation of the disclosure is not limited thereto. For example, in addition to the above-described average value, a map of variance values of the slip amounts of the plurality of normal cases may be calculated. In this case, the calculation of the Mahalanobis distance (a value obtained by dividing the difference from the average value by a variance value) between the slip amount of the inspection target subject and the above-described average value may be performed as the comparison operation in step S10604, and the Mahalanobis distance may be used as the characteristic value. The characteristic value reflecting variations of the slip amounts of the normal cases can be thereby calculated, so that there is such an effect that an observation image more useful for a diagnosis can be provided. Alternatively, the percentile of the slip amount of the inspection target subject with respect to the slip amounts of the plurality of normal cases may be calculated as the characteristic value, and this similarly produces such an effect that an observation image useful for a diagnosis can be provided. Besides the above-described methods, there are various methods for calculating the distance (deviation degree) of the slip amount of the inspection target subject with respect to the distribution of the slip amounts of the normal cases, and any of the methods can be included in the exemplary embodiments of the present disclosure.

### Variation Example 1-2: Separating Generation and Use of Standard Slip Amount Map

In the present exemplary embodiment, the case where the calculation processing for the standard slip amount map is executed after the calculation processing for the slip amount map of the inspection target subject is executed is described as an example, but the implementation of the present disclosure is not limited thereto. For example, the calculation processing for the standard slip amount map may be executed before the calculation processing for the slip amount of the inspection target subject is executed. Further, the implementation of the present disclosure is not limited to the case where the calculation processing for the standard slip amount map and the calculation processing for the slip amount map of the inspection target subject are executed as a series of steps. For example, the calculation processing for the standard slip amount map using the plurality of normal cases as the processing target can be executed beforehand, and the standard slip amount map resulting from this processing can be stored in the inspection image database. Further, the standard slip amount map can be used by reading out from the inspection image database when the characteristic value of the inspection target case is calculated. According to the method described above, the processing of creating the standard slip amount map can be completed before the processing for the inspection target subject is executed, and therefore, there is such an effect that the characteristic value of the inspection target subject can be quickly calculated.

### Variation Example 1-3: For Left and Right Lungs

In the present exemplary embodiment, the case where the characteristic value of the right lung (on the left in the coronal image) of the inspection target subject is calculated and the observation image is generated is described as an example, but the implementation of the present disclosure is not limited thereto. The present exemplary embodiment is also applicable to, for example, a case where the left lung of the inspection target subject is used as a target. In this case, the standard slip amount map can be generated based on the slip amount of the left lung of the normal case by the processing in step S1040. Alternatively, the standard slip amount map of each of the right lung and the left lung of the normal case may be generated beforehand and the standard slip amount map to be used may be selected depending on whether the inspection target of the inspection target subject is the right lung or the left lung. Alternatively, both of the right lung and the left lung of the inspection target subject may be processed using the standard slip amount maps of both of the right lung and the left lung generated by the above-described method.

Alternatively, for example, in a case where the characteristic value of the left lung of the inspection target subject is calculated, the right and left of the standard slip amount map generated based on the slip amount of the right lung of the normal case may be reversed and used. More specifically, a map in which the direction Φ in the equation (1) is reversed can be generated and used. Further, a map may be generated by reversing the direction Φ for the slip amount of the right lung of the normal case and then taking the average with the slip amount of the left lung of the normal case. Alternatively, a map may be generated by generating the standard slip amount map of each of the right lung and the left lung of each of the plurality of normal cases, and calculating the average of both after reversing right and left of one of the standard slip amount maps, depending on the left lung or the right lung used as the inspection target of the inspection target subject, and the generated map may be used as the standard slip amount map.

### Variation Example 1-4: Addition of Normal Case

The information processing apparatus 10 may be configured to further acquire the result of a diagnosis of the adhesion state of the pleura of the inspection target subject by the user, in the processing in step S1080 of the present exemplary embodiment. In this process, in a case where the diagnosis result indicates “no adhesion”, additional information representing a case having no adhesion in a pleura can be added to the data to be stored in the inspection image database 30. With this configuration, when the present disclosure is implemented for a subject other than the inspection target subject of the present exemplary embodiment, the 4D-CT data I_t and the slip amount map S_t of the subject used as the inspection target in the present exemplary embodiment can be used as the data of the normal case.

### Variation Example 1-5: For Different CT Imaging Range

In the present exemplary embodiment, the case where the entire lung of the subject is captured in the 4D-CT data obtained by capturing the inspection target subject is described as an example, but the implementation of the present disclosure is not limited thereto. For example, the 4D-CT data obtained by capturing the inspection target subject may be data in which a part of the lung of the subject (e.g., only an upper part, only a middle part, or only a lower part of the lung) is an imaging region. In this case, it is difficult to obtain all of the lung contour, the lung apex position, and the lung base position by the image processing, as the processing in step S10600 of the present exemplary embodiment, and therefore, the following processing is executed. Specifically, a lung contour, a lung apex position, and a lung base position outside the imaging region can be estimated based on, for example, the positions of other anatomical characteristics within the imaging region such as a bronchus and a bone, in addition to a part of the lung contour, the lung apex position, and the lung base position included in the imaging region. More specifically, it is desirable to perform the estimation based on prior knowledge about a human body structure, such as the shape, the size, and the positional relationship between anatomical characteristics of a lung of a standard human body. To be more specific, the estimation can be performed by executing registration of the captured data of the inspection target subject with respect to a standard human body model including the entire lung. In this case, it is more desirable to select or generate an appropriate human body model based on attribute information such as the height, weight, physical size, and gender of the inspection target subject, and perform the estimation based the appropriate human body model. According to the method described above, a subject for which only a part of the lung is used as the imaging region can be the inspection target subject.

### Variation Example 1-6: Standard Case Other than Normal Case

In the present exemplary embodiment, the case where the standard slip amount map is calculated based on the slip amount map relating to the plurality of normal cases each having no adhesion in a pleura is described as an example, but the implementation of the present disclosure is not limited thereto. For example, the subjects to be used for the calculation of the standard slip amount map may include not only a subject having no adhesion in a pleura, but also a subject having an adhesion in a pleura. To be more specific, the search based on the condition “normal case (no pleural adhesion)” is not necessarily performed when the slip amount map is acquired from the inspection image database 30 in step S10400. In this case, it is desirable to use, as the processing in step S10406, a method that can reduce the influence of the mixture of the case having a pleural adhesion, for example, calculating the median value, instead of calculating the average value of the plurality of slip amount maps. With this method, the standard slip amount map can be generated also using a case where the presence/absence of a pleural adhesion is unclear, and therefore, there is such an effect that an information processing system with a wide range of application in a simpler structure can be provided.

### <Variation of Reference Space: Space of Inspection Target Case (Registration of Contour Shapes of Respective Cases)>

A second exemplary embodiment of the present disclosure will be described. In the first exemplary embodiment, there is described the example in which the standard slip amount map is calculated by performing the coordinate transformation of the slip amount maps of the plurality of normal cases into the reference space expressed by the two parameters that are the geodesic distance from the lung apex position and the direction around the body axis passing through the lung apex position. However, the implementation of the present disclosure is not limited thereto. In the second exemplary embodiment, a case where a standard slip amount map is calculated by performing a coordinate transformation of slip amount maps of a plurality of normal cases into an image space of 3D-CT data at an inspiratory level of an inspection target subject will be described as an example.

The overall configuration of an information processing system according to the second exemplary embodiment of the present disclosure is similar to the configuration illustrated in FIG. 1 and described as the overall configuration of the information processing system according to the first exemplary embodiment. Thus, the detailed description thereof is omitted here.

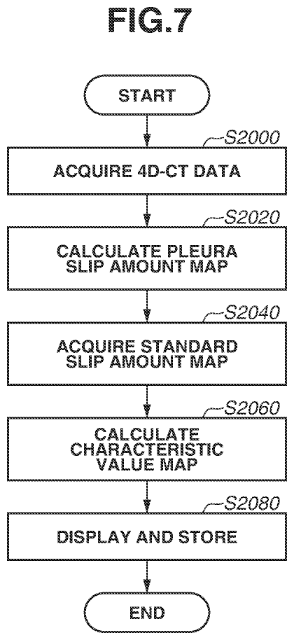

Next, an overall processing procedure by an information processing apparatus 10 in the present exemplary embodiment will be described in detail with reference to FIG. 7.

### <Acquisition of 4D-CT Data>

In step S2000, the information processing apparatus 10 executes processing similar to that in step S1000 of the first exemplary embodiment. Thus, the detailed description thereof is omitted.

### <Calculation of Pleura Slip Amount Map>

In step S2020, the information processing apparatus 10 executes processing similar to that in step S1020 of the first exemplary embodiment. Thus, the detailed description thereof is omitted.

### <Acquisition of Standard Slip Amount Map>

In step S2040, the information processing apparatus 10 acquires information representing slip amounts of a plurality of subjects each having no pleural adhesion from an inspection image database 30, and acquires a standard slip amount map by calculating the average value of those slip amounts. Unlike the first exemplary embodiment, the standard slip amount map in the present exemplary embodiment is generated in an image coordinate system of 3D-CT data I_t_ins at an inspiratory level of an inspection target subject.

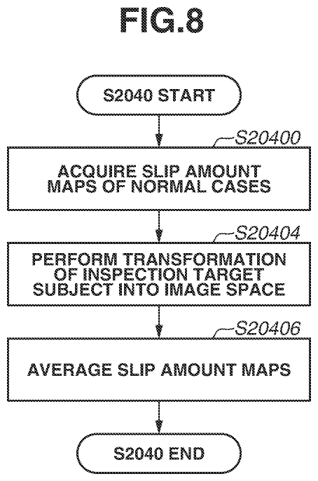

FIG. 8 is a flowchart illustrating a processing flow of this step in detail. The detailed flow of the processing in step S2040 will be described with reference to FIG. 8.

### <Acquisition of Slip Amount Maps of Normal Cases>

In step S20400, a normal case data acquisition unit 120 executes processing similar to step S10400 of the first exemplary embodiment. Thus, the detailed description thereof is omitted.

<Transformation of Inspection Target Subject into Image Space>

In step S20404, a standard slip amount map calculation unit 130 performs a coordinate transformation of each of slip amount maps S_n_j (1≤j≤M) of a plurality of normal cases acquired in step S20400 into the image coordinate system of the 3D-CT data I_t_ins at the inspiratory level of the inspection target subject. This coordinate transformation is performed by executing image registration between 3D-CT data I_n_ins_j (1≤j≤M) at an inspiratory level of each of the normal cases and the 3D-CT data I_t_ins at the inspiratory level of the inspection target subject. The method of the registration between the images of 3D-CT data can be executed using any known method, but it is desirable to perform registration for making the images substantially match with each other in terms of anatomical characteristics. In the present exemplary embodiment, the registration between the images is executed by performing registration between shapes for making a lung contour of the inspection target subject and a lung contour of the normal case substantially match with each other. The coordinate transformation of each of the slip amount maps S_n_j (1≤j≤M) of the normal cases is performed by the above-described method, so that a slip amount map S″_n_j (1≤j≤M) of each of the normal cases after the coordinate transformation is calculated. In the present exemplary embodiment, each of the slip amount maps S″_n_j (1≤j≤M) of the normal cases obtained by the coordinate transformation is held as 3D volume data discretized with granularity at the same level as a slip amount map S_t of the inspection target subject.

### <Averaging of Slip Amount Map>

In step S20406, the standard slip amount map calculation unit 130 executes processing of calculating a standard slip amount map by integrating the slip amount maps S″_n_j (1≤j≤M) of the respective normal cases resulting from the coordinate transformation in step S20404. In the present exemplary embodiment, the standard slip amount map is expressed as a standard slip amount map R″_n. In the present exemplary embodiment, a case where an average value calculation operation is used as an operation for integrating the slip amount maps of the plurality of normal cases will be described as an example. More specifically, the standard slip amount map R″_n is calculated by an equation (3).

$${R}^{″} \_n ( x ) = \frac{{S}^{″} \_t ( x )}{M} \qquad ( 3 )$$

In the present exemplary embodiment, the standard slip amount map R″_n is held as 3D volume data discretized with granularity at the same level as that of the slip amount map S″_n_j (1≤j≤M).

The processing in step S2040 is executed by the above-described processing in step S20400 to step S20406.

### <Characteristic Value Map Calculation>

In step S2060, a slip characteristic value calculation unit 140 calculates a characteristic value map C_t relating to the slip amount of the inspection target subject by comparing the slip amount map S_t of the inspection target subject calculated in step S2020 and the standard slip amount map R″_n calculated in step S2040.

In this processing step, the slip characteristic value calculation unit 140 executes processing of calculating the characteristic value map C_t relating to the slip of the pleura of the inspection target case, by performing a comparison operation for comparison between the slip amount map S_t of the inspection target subject calculated in step S2020 and the standard slip amount map R″_n calculated in step S2040. In the present exemplary embodiment, processing of calculating the logarithm of the ratio between the slip amount map S_t and the standard slip amount map R″_n is executed as the comparison operation. More specifically, the characteristic value map C_t is calculated by an equation (4).

$$C\_t ( x ) = log ( \frac{S\_t ( x )}{{R}^{″} \_n ( x )} ) \qquad ( 4 )$$

The calculated characteristic value map C_t is held as 3D volume data discretized with predetermined granularity, as with the slip amount map S_t.

### <Display and Storage>

In step S2080, a display control unit 150 executes processing similar to that in step S1080 of the first exemplary embodiment. Thus, the detailed description thereof is omitted here.

The processing of the information processing apparatus 10 in the present exemplary embodiment is executed by the method described above. In the second exemplary embodiment of the present disclosure, there is such an effect that the number of times the coordinate transformation processing is executed is less and the present disclosure can be implemented by simpler processing than that in the first exemplary embodiment.

### Variation Example 2-1

In the present exemplary embodiment, the case where the standard slip amount map is generated by performing the registration (coordinate transformation) of each of the slip amount maps of the plurality of normal cases with the lung contour at the inspiratory level of the inspection target subject is described as an example, but the implementation of the present disclosure is not limited thereto. For example, the standard slip amount map may be generated by performing registration of each of the slip amount maps of the plurality of normal cases with the average lung shape. In this case, desirably, the calculation (comparison operation) of a characteristic value after the standard slip amount map is registered to match the lung of the inspection target subject substantially with the anatomical characteristics is performed as the processing in step S2060. With the method described above, there is such an effect that the standard slip amount map can be generated in a robust manner, even in a case where the shape of the lung contour is different from that of the normal case to a great extent, such as a case where the lung of the inspection target subject is partially removed by surgery or the like.

### <Variation of Acquisition of Normal Case: Calculation of Standard Slip Amount Map Based on Selected Case Analogous to Inspection Target Subject>

A third exemplary embodiment of the present disclosure will be described. Unlike the first exemplary embodiment, a standard slip amount map is generated based on a slip amount of a normal case having attributes analogous to those of an inspection target subject.

The present exemplary embodiment has a functional configuration similar to that of the first exemplary embodiment described with reference to FIG. 1, and is executed by processing steps similar to those of the first exemplary embodiment described with reference to FIG. 2. However, a part of processing corresponding to the processing in step S10400 in FIG. 4 is different. Of the processing steps in the third exemplary embodiment, the part different from the first exemplary embodiment will be described.

In the processing in step S10400 in the present exemplary embodiment, a standard slip amount map calculation unit 130 acquires slip amount maps of a plurality of normal cases (cases each having no pleural adhesion) from an inspection image database 30, as with the first exemplary embodiment. However, the execution of the processing is limited to a case having attributes analogous to those of the inspection target subject, among a plurality of subjects held in the inspection image database 30. More specifically, based on attribute information including the age, gender, medical history, height, weight, physical size, and race of the inspection target subject, the execution of the processing is limited to a subject having attributes analogous to these attributes. To be more specific, the execution of the processing can be limited to a predetermined number of subjects each having gender and race attributes that are identical to those of the inspection target subject and having a high degree of coincidence of other attributes (or subjects each having a degree of coincidence exceeding a predetermined threshold). Further, the execution of the processing may be limited to, not only the subjects each having the above-described attribute information, but also, for example, subjects each having a lung field cubic content, a lung contour shape, and the like that are analogous to those of the inspection target subject. In this case, it is desirable that the execution of the processing be limited to, in particular, a subject having characteristics of respiratory movement of a lung that are analogous to those of the inspection target subject. The criteria for the selection in limiting the normal cases is not limited to the above-described example, and other criteria may be used.

The implementation of the present disclosure is not limited to the above-described example. For example, based on the gender of the normal case, the standard slip amount map for each of male and female is calculated beforehand, and the standard slip amount map corresponding to the gender of the inspection target subject may be selected and used. The method of calculating the standard slip amount map beforehand is not limited to this example. The ages of subjects can be divided into a plurality of classes, and the standard slip amount map can be calculated for each of the classes. Further, a plurality of standard slip amount maps may be calculated beforehand based on combinations of gender and age, and based on the gender and age of the inspection target subject, the standard slip amount map may be selected from these calculated standard slip amount maps, and used.

By the above-described method in step S10400 of the present exemplary embodiment, the slip amounts of the normal cases each having attributes analogous to those of the inspection target subject are acquired, and the standard slip amount map is acquired by executing the processing in and after step S10402 based on the acquired slip amounts. With this method, there is such an effect that the characteristic value less affected by variations of the respiratory movement among cases can be calculated.

### Variation Example 3-1

In the present exemplary embodiment, the method of acquiring the standard slip amount map based on the slip amounts of the subjects, other than the inspection target subject, that have attributes analogous to those of the inspection target subject is described as an example, but the implementation of the present disclosure is not limited thereto. For example, a past slip amount map of the same subject as the inspection target subject may be used as the standard slip amount map. With this method, there is such an effect that the characteristic value map, which reflects a change over time, relating to the slip amount of the pleura of the inspection target subject is generated, and thus there is such an effect that an observation image from which it is easy to visually recognize the change over time can be provided. In other words, there is such an effect that it is possible to provide an observation image from which it is easy to visually recognize the present/absence of a new pleural adhesion not present in the past.

<Example Other than Slip: Modeling of Movement of Lung Contour: 3D Vector or Moving Distance>

The case where the slip amount of the pleura (surface of the lung) of the human body is used is described above as an example in the exemplary embodiments of the present disclosure, but the implementation of the present disclosure is not limited thereto. In a fourth exemplary embodiment of the present disclosure, for example, a movement (moving amount) of a lung surface caused by respiratory movement is used. In this case, in place of the above-described calculation processing for the slip amount (e.g., step S1020 of the first exemplary embodiment), calculation processing for the moving amount of the lung can be performed. In a case where the moving amount of the lung is used as a target, for example, the moving amount of the lung can be calculated by performing registration of a region of the lung, between 3D-CT data at an inspiratory level and 3D-CT data at an expiratory level. In this case, the moving amount of the lung may be a distance (scalar value) of the movement, or may be a vector of the movement. In a case where the vector of the movement of the lung is used, the processing may be performed independently for the moving amount in each axis direction in a three-dimensional space, and a characteristic value may be calculated by integrating the results thereof. Alternatively, the vector of the movement in the three-dimensional space may be separated into the distance and the direction of the movement, the processing may be performed independently for each of these, and the characteristic value may be calculated by integrating the results thereof.

Further, the implementation of the present disclosure is not limited to the above-described example. A case where any other physical fluctuation caused by the respiratory movement, such as a local ventilation volume or a ratio of expansion and contraction of the lung, or a concentration change in 3D-CT data, is used as a target can also be included in the exemplary embodiments of the present disclosure.

### Other Exemplary Embodiments

It is also possible to combine at least two of the plurality of variation examples described above.

The technology of the disclosure can also take the form of, for example, a system, an apparatus, a method, and a program or a recording medium (storage medium). More specifically, the technique may be applied to a system composed of a plurality of apparatuses (e.g., a host computer, an interface device, an imaging apparatus, and a web application), or may be applied to an apparatus consisting of one device.

In the above-described exemplary embodiments, the example in which the characteristic value of the movement of the lung is calculated is described, but the exemplary embodiments are applicable to a case where a characteristic value of movement of any target site other than the lung, such as heart, is calculated.

It is needless to say that the present disclosure is achieved as follows. A recording medium or a storage medium stores a program code (computer program) of software for implementing the functions of the above-descried exemplary embodiments, and is supplied to a system or apparatus. The storage medium is a computer readable storage medium. A computer, a central processing unit (CPU), or micro processing unit (MPU) of the system or apparatus reads out the program code stored in the storage medium and executes the program code. In this case, the program code read out from the storage medium implements the functions of the above-described exemplary embodiments, and the storage medium storing the program code constitutes an exemplary embodiment of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-153003, filed Sep. 11, 2020, which is hereby incorporated by reference herein in its entirety.

What is claimed is:

1. An information processing apparatus comprising:
a first acquisition unit configured to acquire a characteristic amount relating to movement of a target site of a subject;
a second acquisition unit configured to acquire a standard characteristic amount, based on a characteristic amount relating to movement of a target site of a standard subject different from the subject; and
a calculation unit configured to calculate a characteristic value relating to the movement of the target site of the subject, based on the characteristic amount relating to the movement of the target site of the subject and the standard characteristic amount,
wherein the second acquisition unit performs a coordinate transformation of the characteristic amount of the standard subject into a reference space, and calculates the standard characteristic amount, based on a characteristic amount resulting from the coordinate transformation.

2. The information processing apparatus according to claim 1, wherein the target site is a lung.

3. The information processing apparatus according to claim 2,
wherein the first acquisition unit acquires a slip amount of a pleura of the subject as the characteristic amount relating to the movement of the lung of the subject,
wherein the second acquisition unit acquires a slip amount of a pleura of the standard subject as the characteristic amount relating to the movement of the lung of the standard subject, and
wherein the calculation unit calculates a characteristic value relating to a slip of the pleura as the characteristic value relating to the movement of the lung of the subject.

4. The information processing apparatus according to claim 1, wherein the calculation unit performs a coordinate transformation of the characteristic amount of the subject into the reference space, and calculates the characteristic value, based on a characteristic amount of the subject resulting from the coordinate transformation, and the standard characteristic amount.

5. The information processing apparatus according to claim 2, wherein the second acquisition unit or the calculation unit changes a processing method for the coordinate transformation, based on whether the lung of the subject is a left lung or a right lung.

6. The information processing apparatus according to claim 2, wherein the second acquisition unit selects a standard subject to be used as a target for acquiring the standard characteristic amount, from a plurality of standard subjects, based on information about an attribute of the subject.

7. The information processing apparatus according to claim 2, wherein the coordinate transformation is performed based on a position of a lung apex or a lung base of the standard subject.

8. The information processing apparatus according to claim 1, further comprising a display control unit configured to display the characteristic value on a display unit.

9. The information processing apparatus according to claim 8, wherein the display control unit displays the characteristic value together with the characteristic amount of the subject.

10. An information processing apparatus comprising:
an acquisition unit configured to acquire a standard characteristic amount by performing a coordinate transformation of a characteristic amount relating to movement of a pleura of a lung of a standard subject into a reference space, and calculating the standard characteristic amount based on a characteristic amount resulting from the coordinate transformation.

11. The information processing apparatus according to claim 1, wherein the reference space is a coordinate system in which a parameter relating to a position of the target site is set as a coordinate axis.

12. An information processing method comprising:
performing first acquisition of a characteristic amount relating to movement of a target site of a subject;
performing second acquisition of acquiring a standard characteristic amount, based on a characteristic amount relating to movement of a target site of a standard subject different from the subject; and
calculating a characteristic value relating to the movement of the target site of the subject, based on the characteristic amount relating to the movement of the target site of the subject and the standard characteristic amount,
wherein, in the second acquisition, a coordinate transformation of the characteristic amount of the standard subject into a reference space is performed, and the standard characteristic amount is calculated based on a characteristic amount resulting from the coordinate transformation.

13. The information processing method according to claim 12, wherein the target site is a lung.

14. A non-transitory storage medium storing a program for executing the information processing method according to claim 12.
